(19) United States
(12) Patent Application Publication
(10) Pub. No.: US 2009/0309890 A1
(43) Pub. Date: Dec. 17, 2009

(54) DISPLAY DEVICE, CONTROL METHOD THEREOF, PROGRAM AND RECORDING MEDIUM

(75) Inventors: Ryosuke Mizuno, Tokyo (JP); Yukihiko Sakashita, Kawasaki-shi (JP); Akihiro Ouchi, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/480,184

(22) Filed: Jun. 8, 2009

(30) Foreign Application Priority Data
Jun. 13, 2008 (JP) 2008-155884

(51) Int. Cl. G09G 5/36

(52) U.S. Cl. 345/547; 345/87

(57) ABSTRACT

A display device that receives an input of video signal data including a plurality of pieces of frame data, corrects frame data representing a frame to be displayed based on frame data of a frame adjacent to the frame to be displayed, and outputs the resulting data as data to be displayed on a liquid crystal panel. The device comprises a memory unit adapted to store input frame data. The device determines a correction address used to determine a frame correction amount by comparing the stored frame data and frame data that is currently input; determines correction data that represents a correction amount of the frame data based on the stored frame data and the correction address; and corrects the frame data by adding and/or subtracting the correction amount represented by the correction data to or from the stored frame data.

### BACKGROUND OF THE INVENTION

1. Field of the Invention

The present invention relates to a display device, a control method thereof, a program, and a recording medium, and more particularly to a technique for optimizing a liquid crystal response velocity according to changes in the gradation of an input video signal.

2. Description of the Related Art

In recent years, liquid crystal display devices are being used as TV receivers and display devices for personal computers. As they are thin, space-saving and energy-saving, liquid crystal display devices have a wide variety of applications. However, liquid crystal display devices have a low response velocity, that is, the time from a change in an input video signal until the actual display is long, so problems arise when displaying moving images, such as the occurrence of afterimages. In order to improve the liquid crystal response velocity, Japanese Patent No. 3305240 has proposed what is called “over-voltage drive” in which a video signal to be displayed in the next frame is compared with the video signal displayed in the previous frame are compared, an input video signal is corrected according to the result of the comparison, and the liquid crystal is driven with the corrected signal. By performing such over-voltage driving in a short time, the effect of improving the liquid crystal response velocity is further enhanced. For this purpose, a configuration disclosed in Japanese Patent Laid-Open No. 2001-343956 is known in which, for example, one input frame is divided into a plurality of fields to drive a liquid crystal, and over-voltage driving is performed on an initial field.

The principles of over-voltage driving will be explained briefly with reference to FIGS. 8 and 9. FIG. 8 is a schematic diagram illustrating a liquid crystal driving signal and a liquid crystal response characteristic when over-voltage driving is performed at the same frame rate as the frame rate of an input video signal. FIG. 9 is a schematic diagram illustrating a liquid crystal driving signal and a liquid crystal response characteristic when the frame rate is converted to a frame rate twice the frame rate of an input video signal, and over-voltage driving is performed on an initial field of the converted frame.

In FIG. 8, the horizontal axis represents time, and the vertical axis represents a liquid crystal driving signal and the level of response to the signal. Reference numeral 801 indicates the normal state of a liquid crystal driving signal, and 802 indicates a liquid crystal response to the liquid crystal driving signal 801. Reference numeral 803 indicates a change of the liquid crystal driving signal that has undergone over-voltage driving, and 804 indicates a liquid crystal response to the liquid crystal driving signal 803. As can be seen from a comparison of the liquid crystal responses 802 and 804, the liquid crystal response to the liquid crystal driving signal that has undergone over-voltage driving has an improved liquid crystal response velocity.

In FIG. 9 as well, the horizontal axis represents time, and the vertical axis represents a liquid crystal driving signal and the level of response to the signal. Reference numeral 901 indicates a normal state of a liquid crystal driving signal, 902 indicates a liquid crystal response to the liquid crystal driving signal 901, 903 indicates a change of the liquid crystal driving signal that has undergone over-voltage driving, and 904 indicates a liquid crystal response to the liquid crystal driving signal 903. As can be seen from a comparison of the liquid crystal responses 804 and 904, in FIG. 9 in which the frame rate has been converted to double the input frame rate, the liquid crystal response velocity is further improved.

The above-described configuration in which one frame is divided into a plurality of fields and over-voltage driving is performed on an initial field is compatible with a reflective liquid crystal display panel (LCOS: Liquid Crystal on Silicon) driving technique. This is because a reflective liquid crystal display panel converts the frame rate of an input signal to a double frame rate, and performs polarity inversion for each double-speed frame of the double-speed frame signal.

In order to convert an input signal to a double frame rate (double-speed conversion), it is necessary to store one frame's worth of video signal in a frame memory, and read out the signal at double speed. In addition, in order to perform over-voltage driving for the purpose of improving liquid crystal response velocity, it is necessary to store the video signal of the previous frame in a frame memory so as to compare the video signal of the current frame and that of the previous frame. That is, a frame memory is necessary in each processing block, but when a frame memory is provided separately in each block, the size of the frame memory and the size of the control unit therefor increase, making the control thereof complicated.

In view of the foregoing, the present applicant has proposed, in Japanese Patent Laid-Open No. 2008-70561, a liquid crystal device in which a frame memory for double-speed conversion and a frame memory for over-voltage driving are integrated into a common frame memory, with which liquid crystal response velocity characteristics can be improved without complicating the memory configuration and the control thereof.

According to the configuration described in Japanese Patent Laid-Open No. 2008-70561, the video signal data of the previous frame stored in a frame memory is first read out at the same rate as the frame rate of an input video signal. Signal levels are compared between the video signal data of the previous frame and the input video signal data, and the result of the comparison is output as correction data of, for example, 4 bits. If the input video signal data is of 12 bits, the 4-bit correction data is appended to the MSB (most significant bit) or LSB (least significant bit) of the input video signal data, and the resulting 16-bit data is output to a frame memory for double-speed conversion. Then, the 16-bit data that has undergone double-speed conversion refers to the 4-bit correction data appended to the MSB or LSB, and 12-bit video signal data whose response velocity has been corrected based on that correction data is generated.

In this way, a frame memory for double-speed conversion and a frame memory for over-voltage driving are integrated into a common frame memory, and liquid crystal response velocity characteristics can be improved without complicating the memory configuration and the control thereof.

In the configuration described in Japanese Patent Laid-Open No. 2008-70561, if the number of bits of the correction data necessary for over-voltage driving is increased to further improve the accuracy of over-voltage driving, the necessary number of frame memories also increases.

### SUMMARY OF THE INVENTION

The present invention aims to provide a liquid crystal display technique with which it is possible to further improve the accuracy of over-voltage driving while suppressing an increase in the number of frame memories in a configuration for comparing video signal levels for over-voltage driving.

According to one aspect of the present invention, a display device that receives an input of video signal data including a plurality of pieces of frame data, corrects frame data representing a frame to be displayed based on frame data of a frame adjacent to the frame to be displayed, and outputs the resulting data as data to be displayed on a liquid crystal panel, the device comprises: a memory unit adapted to store input frame data; a first determining unit adapted to determine a correction address used to determine a frame correction amount by comparing frame data stored in the memory unit and frame data that is currently input; a second determining unit adapted to determine correction data that represents a correction amount of the frame data based on the frame data stored in the memory unit and the correction address; and a correcting unit adapted to correct the frame data by adding and/or subtracting the correction amount represented by the correction data to or from the frame data stored in the memory unit.

According to another aspect of the present invention, a method of controlling a display device that receives an input of video signal data including a plurality of pieces of frame data, corrects frame data representing a frame to be displayed based on frame data of a frame adjacent to the frame to be displayed, and outputs the resulting data as data to be displayed on a liquid crystal panel, the method comprises the steps of: storing input frame data; determining a correction address used to determine a frame correction amount by comparing frame data stored in the memory unit and frame data that is currently input; determining correction data that represents a correction amount of the frame data based on the frame data stored in the memory unit and the correction address; and correcting the frame data by adding and/or subtracting the correction amount represented by the correction data to or from the frame data stored in the memory unit.

Further features of the present invention will become apparent from the following description of exemplary embodiments with reference to the attached drawings.

### BRIEF DESCRIPTION OF THE DRAWINGS

FIG. 1 is a schematic block diagram of a liquid crystal display device.

FIG. 2 is a diagram used to illustrate an operation of a memory control unit.

FIG. 3 is a diagram used to illustrate an operation of a memory control unit.

FIG. 4 is a diagram illustrating an example of a correction address determination table.

FIG. 5 is a diagram illustrating an example of a correction data determination table.

FIG. 6 is a diagram illustrating an example of a correction data determination table.

FIG. 7 is a diagram used to illustrate a process for interpolating correction data.

FIG. 8 is a schematic diagram illustrating a liquid crystal driving signal and a liquid crystal response characteristic when over-voltage driving is performed at the same frame rate as the frame rate of an input video signal.

FIG. 9 is a schematic diagram illustrating a liquid crystal driving signal and a liquid crystal response characteristic when the frame rate is converted to a frame rate twice the frame rate of an input video signal, and over-voltage driving is performed on an initial field of the converted frame.

### DESCRIPTION OF THE EMBODIMENTS

Hereinafter, embodiments of the present invention will be described in detail with reference to the accompanying drawings. It should be noted, however, that the constituent elements described in the following embodiments are merely exemplary, and are not intended to limit the scope of the present invention. It should also be noted that not all the combinations of the features described in the embodiments are necessary to solve the problems of the present invention.

### Embodiment 1

### Configuration of Liquid Crystal Display Device

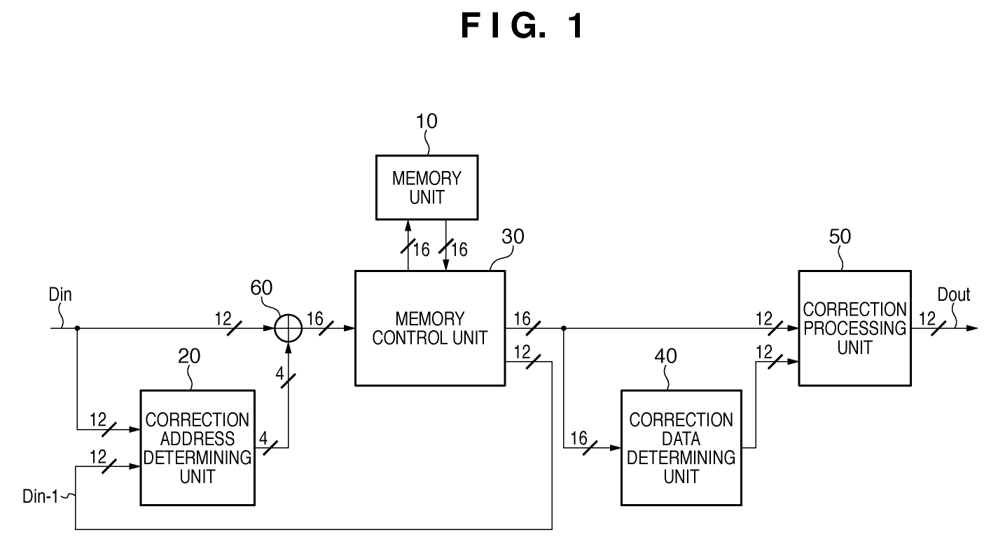

FIG. 1 is a schematic block diagram of a liquid crystal display device according to Embodiment 1 of the present invention. This liquid crystal display device receives an input of video signal data including a plurality of pieces of frame data, corrects frame data representing a frame to be displayed based on the frame data of a frame adjacent to the frame to be displayed, and outputs the resulting data as data to be displayed on a liquid crystal panel. Reference numeral 10 denotes a memory unit, 20 denotes a correction address determining unit, 30 denotes a memory control unit, 40 denotes a correction data determining unit, 50 denotes a correction processing unit, and 60 denotes a correction address appending unit.

In this configuration, the memory unit 10 is a functional element as a memory unit for storing video signal data (frame data included in video signal data). The memory unit 10 can be implemented with, for example, DDR-SDRAM (Double Data Rate-Synchronous DRAM), SDR-SDRAM (Single Data Rate-Synchronous DRAM) or the like.

The memory control unit 30 is a functional element that controls the readout and write processes of the memory unit 10. The memory control unit 30 reads out the previous frame's video signal data Din-1 stored in the memory unit 10 at the same rate as the frame rate of input video signal data Din, and outputs the data to the correction address determining unit 20.

The correction address determining unit 20 is a functional element that determines a correction address used to determine a frame correction amount by comparing the frame data stored in the memory unit 10 with the frame data currently input. The correction address determining unit 20 compares signal levels between the previous frame's video signal data Din-1 (e.g., 12 bits) read out from the memory control unit 30 and the input video signal data Din (also 12 bits), and then outputs the result of the comparison to the correction address appending unit 60 as a correction address of, for example, 4 bits. As will be described later, the correction address determining unit 20 reads out the frame data stored in the memory unit 10 at the same velocity as that used to input frame data, and performs a comparison.

The correction address appending unit 60 appends the 4-bit correction address to the MSB or LSB of the 12-bit input video signal data Din, and outputs the resulting 16-bit data to the memory control unit 30. In other words, the correction address determined by the correction address determining unit 20 is appended to the currently input frame data, and stored in the memory unit 10.

The memory control unit 30 writes the 16-bit data output from the correction address appending unit 60 into the memory unit 10, converts (double-speed conversion) the stored 16-bit data to, for example, a frame rate twice that of the input video signal, and outputs the resulting data to the correction data determining unit 40 and the correction processing unit 50.

The correction data determining unit 40 is a functional element that determines correction data representing a correction amount of the frame data based on the frame data and correction address stored in the memory unit 10. Specifically, correction data of, for example, 12 bits that will be used in an over-voltage drive correction process is generated based on the 16-bit data output from the memory control unit 30. Then, the generated correction data is output to the correction processing unit 50. The correction data determining unit 40 reads out the frame data stored in the memory unit 10 at a velocity n (>1) times that used to input frame data, and determines the correction data.

The correction processing unit 50 is a functional element that corrects the frame data by adding and/or subtracting the correction amount indicated by the correction data to or from the frame data stored in the memory unit 10. The correction processing unit 50 refers to the 12-bit correction data output from the correction data determining unit 40, corrects the response velocity of the 12-bit video signal data included in the 16-bit data output from the memory control unit 30 to generate 12-bit output video signal data Dout, and outputs the 12-bit output video signal data Dout. The output video signal data Dout is then converted to a format suitable for input into a liquid crystal panel.

Operation of Memory Control Unit

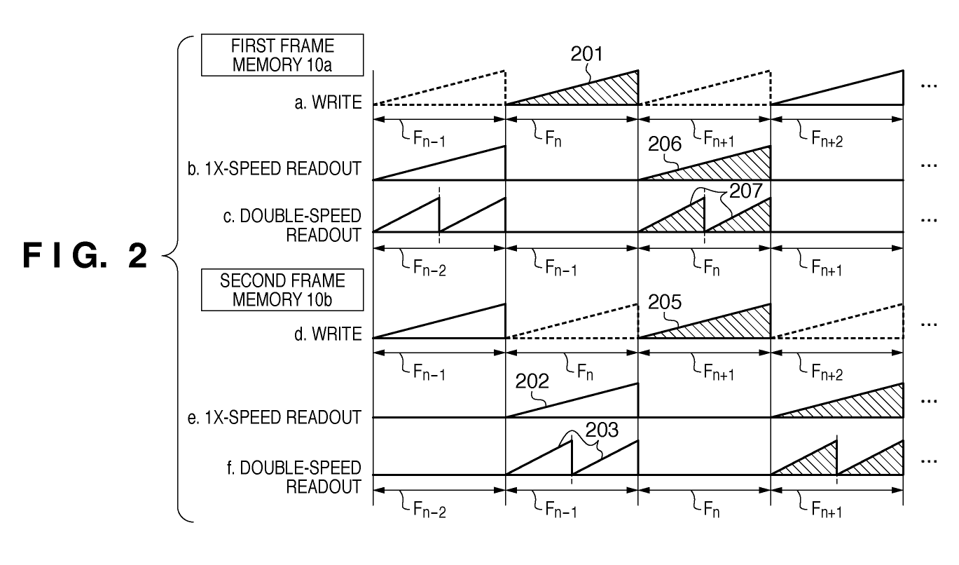

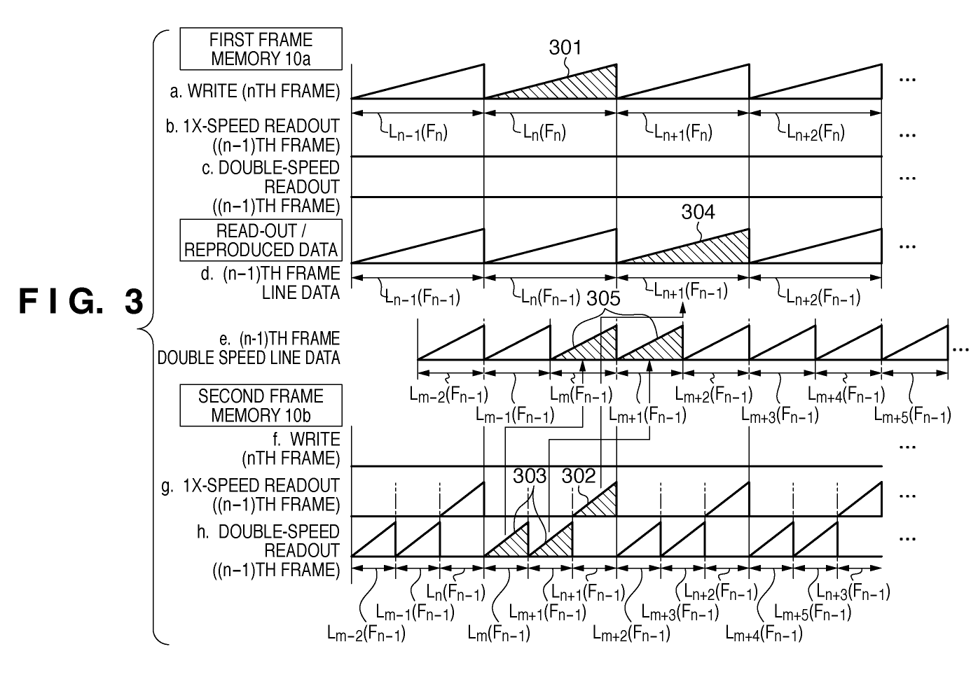

An operation of the memory control unit 30 of the present embodiment will be described next with reference to FIGS. 2 and 3. FIG. 2 is a timing diagram used to illustrate the write and readout operations performed by the memory unit 10 in a frame period. FIG. 2 shows an example in which data is converted to a frame rate twice that of the input video signal (double-speed conversion) and output.

The memory unit 10 of the present embodiment includes a first frame memory 10a and a second frame memory 10b (not shown). In a frame Fn, readout control of the first frame memory 10a is activated, and the signal data input into the memory control unit 30 is written into the first frame memory 10a as shown in a. WRITE of FIG. 2 (201). The signal data written in the first frame memory 10a is data in which the correction address determined by the correction address determining unit 20 has been appended to the MSB or LSB.

In the frame Fn, the second frame memory 10b does not perform a write operation. The second frame memory 10b reads out video signal data from signal data that was stored in a previous frame Fn−1 at the same rate as that of the input video signal data Din as shown in e. 1X-SPEED READOUT of FIG. 2 (1x-speed readout, 202). The video signal data read out at the same rate as that of the input video signal data Din is output to the correction address determining unit 20 as previous frame's video signal data Din-1, and will be used in the comparison with the input video signal data Din in terms of signal level.

The second frame memory 10b further reads out the signal data stored in the previous frame Fn−1 at a frame rate twice that of the input video signal as shown in f. DOUBLE-SPEED READOUT of FIG. 2 (double-speed readout, 203), and outputs the frame read out at double speed to the correction data determining unit 40 and the correction processing unit 50 (203). The signal data read out at a frame rate twice that of the input video signal is data in which the correction address determined by the correction address determining unit 20 has been appended to the MSB or LSB.

In the same way, in the next frame Fn+1, write control on the second frame memory 10b is activated, and the video signal data is written into the second frame memory 10b as shown in d. WRITE of FIG. 2 (205). The first frame memory 10a, on the other hand, does not perform a write operation, and reads out the video signal data stored in the previous frame Fn at the same rate as that of the input video signal Din as shown in b. 1X-SPEED READOUT of FIG. 2 (206) and also at a double frame rate as shown in c. DOUBLE-SPEED READOUT of FIG. 2 (207).

The video signal data (206) read out at the same rate as that of the input video signal Din as shown in b. 1X-SPEED READOUT of FIG. 2 is used as previous frame data in the comparison performed by the correction address determining unit 20 with the current frame data, namely, input video signal data Din. The video signal data written into the second frame memory 10b is data in which the correction address determined by the correction address determining unit 20 has been appended to the MSB or LSB.

The write and readout of video signal data will be described in detail with reference to FIG. 3. FIG. 3 is a timing diagram used to illustrate the write and readout operations performed by the memory unit 10 in a line period of a frame Fn. FIG. 3 shows an example in which data is converted to a frame rate twice that of the input video signal (double-speed conversion) and output.

In a frame Fn, write control is activated in the first frame memory 10a, and the signal data input into the memory control unit 30 is written into the first frame memory 10a on a line-by-line basis as shown in a. WRITE (nTH FRAME) of FIG. 3 (301). The second frame memory 10b, on the other hand, does not perform a write operation, and reads out a video signal data line Ln+1 from the signal data stored in the previous frame Fn−1 in a period equal to one-third of a line Ln as shown in g. 1X-SPEED READOUT ((n−1) TH FRAME) of FIG. 3 (302).

The video signal data read out from the second frame memory in g. 1X-SPEED READOUT ((n−1) TH FRAME) of FIG. 3 is stored temporarily in line memories (not shown), and then reproduced in synchronization with a line Ln of the input video signal data Din as video signal data Din-1 of line Ln+1 of the frame Fn−1 as shown in d. (n−1) TH FRAME LINE DATA OF FIG. 3 (304). The video signal data Din-1 will be used in the comparison with the input video signal data Din in terms of signal level performed by the correction address determining unit 20.

Furthermore, the second frame memory 10b reads out lines Lm and Lm+1 of the signal data stored in the previous frame Fn−1 in a period equal to two-thirds of the line Ln as shown in h. DOUBLE-SPEED READOUT ((n−1) TH FRAME) of FIG. 3 (303). The signal data read out from the second frame memory in h. DOUBLE-SPEED READOUT ((n−1) TH FRAME) of FIG. 3 is also stored temporarily in line memories (not shown), then reproduced at a timing delayed by half a period as signal data of the lines Lm and Lm+1 of the previous frame Fn−1 as shown in e. (n−1) TH FRAME DOUBLE SPEED LINE DATA of FIG. 3 (305), and output to the correction data determining unit 40 and the correction processing unit 50. The signal data read out here is data in which the correction address determined by the correction address determining unit 20 has been appended to the MSB or LSB.

In the next frame Fn+1, the write control of the second frame memory 10b is activated, the readout control of the first frame memory 10a is activated, and the same write and readout controls as described above are performed.

The foregoing has described the operation of the memory control unit 30 of the present embodiment with reference to FIGS. 2 and 3, but the present embodiment is not limited to double-speed conversion as described above and using, for example, another frame rate conversion, IP conversion, or the like, a previous frame's video signal data Din-1 may be read out at the same rate as the frame rate of input video signal data Din.

Operation of Correction Address Determining Unit

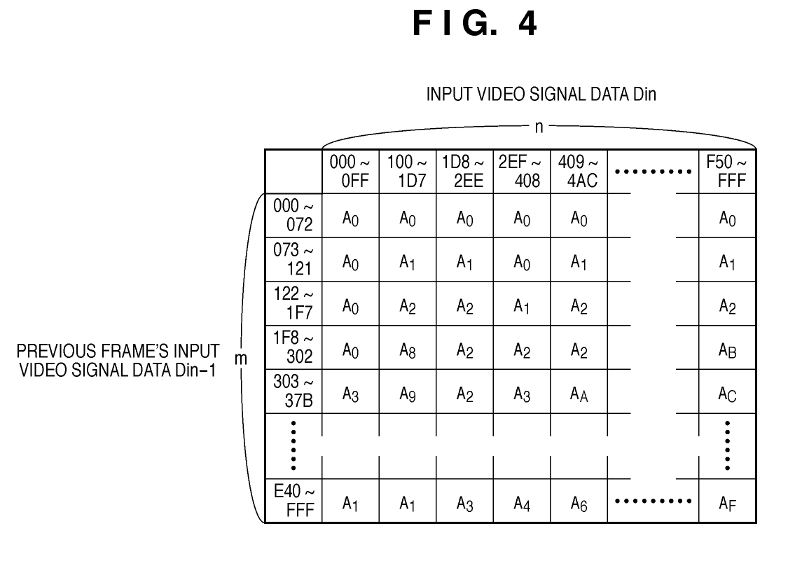

An operation of the correction address determining unit 20 of the present embodiment will be described next with reference to FIG. 4. The correction address determining unit 20 compares signal levels between the previous frame's video signal data Din-1 (e.g., 12 bits) read out from the memory control unit 30 and the input video signal data Din (also 12 bits), and then outputs the result of the comparison to the correction address appending unit 60 as a correction address of, for example, 4 bits.

More specifically, the correction address determining unit 20 refers to a look-up table that shows correspondence between the data of mutually adjacent frames and correction addresses to determine a correction address. In other words, in order to determine a correction address, a look-up table (also referred to as a “correction address determination table”) that includes combinations of previous frame's video signal data Din-1 and input video signal data Din is used. FIG. 4 is a diagram showing an example of a correction address determination table of the present embodiment.

The correction address determination table is a table for defining a correction address for each combination of input video signal data Din and previous frame's video signal data Din-1. In the correction address determination table shown in FIG. 4, the signal level of 12-bit input video signal data Din is divided into n blocks, the signal level of the previous frame's video signal data Din-1 is divided into m blocks, and a 4-bit correction address (16 in total) is assigned to each cell.

As will be described later, the subsequent correction data determining unit 40 is capable of determining correction data according to the correction address corresponding to each level of the input video signal data. Accordingly, in the correction address determination table, it is advisable to assign correction addresses corresponding to the previous frame's video signal data Din-1 to each of the n blocks into which the signal level of input video signal data Din has been divided. If, for example, the signal level of input video signal data Din is divided into 128 blocks, it is advisable to assign 16 correction addresses corresponding to the previous frame's video signal data Din-1 to each of the 128 blocks.

The signal level threshold used when dividing the signal level can be any value, and the number of divided blocks may be increased for, for example, a signal level at which the response velocity is improved with high efficiency by over-voltage driving. With this configuration, it becomes possible to correct the signal level precisely and accurately.

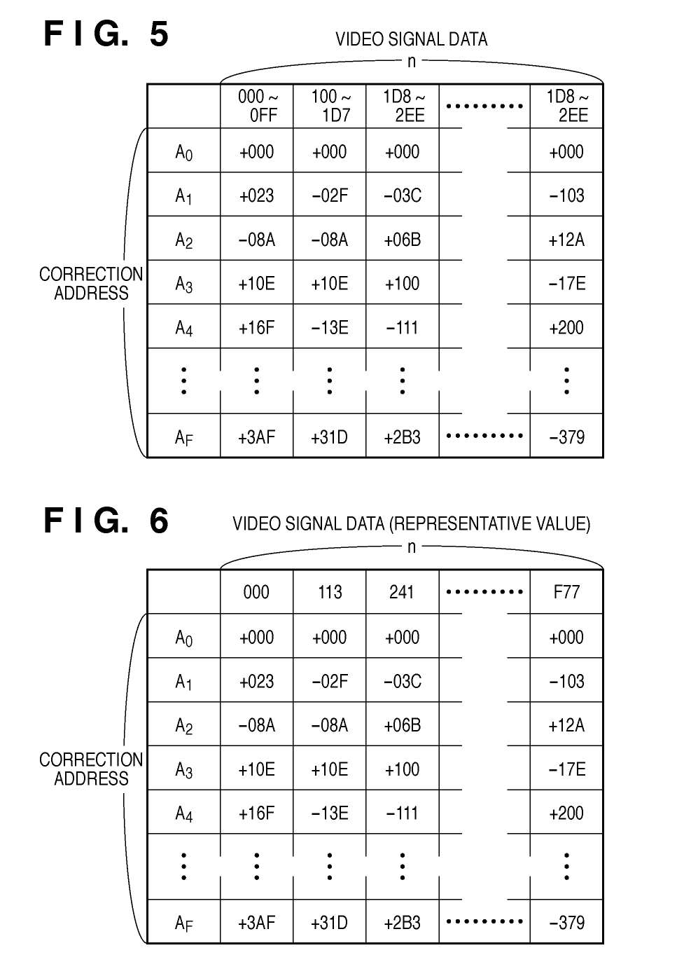

Operation of Correction Data Determining Unit An operation of the correction data determining unit 40 of the present embodiment will be described next with reference to FIG. 5. The correction data determining unit 40 generates correction data (e.g., 12 bits) that will be used in an over-voltage drive correction process based on the 16-bit data output from the memory control unit 30. As used herein, “16-bit data” is signal data output from the memory control unit 30 as just described, and a signal (namely, Din-1) that has undergone, for example, double-speed conversion after being delayed from the input video signal data Din by one frame. Specifically, in order to determine the correction data, based on the 16-bit data, a table (also referred to as a “correction data determination table”) that includes combinations of 12-bit video signal data and 4-bit correction addresses is used. In other words, the correction data determining unit 40 refers to the look-up table that shows the correspondence between frame data, correction addresses, and correction data to determine the correction data.

FIG. 5 is a diagram showing an example of a correction data determination table of the present embodiment. As shown in FIG. 5, the correction data determination table is a table for defining correction data for each combination of video signal data and a correction address. In the example of FIG. 5, 12-bit correction data is assigned, as an example, to the table including combinations of 12-bit video signal data that has been divided into n blocks and 4-bit correction addresses.

As used herein, “12-bit video signal data” is a signal (namely, Din-1) that has undergone, for example, double-speed conversion after being delayed from the input video signal data Din by one frame as described above. Accordingly, it is desirable that the number of blocks into which the 12-bit video signal data is divided and the signal level threshold used when dividing are the same as the number of blocks into which the input video signal data Din has been divided and the signal level threshold used when dividing that were set for the correction address determination table.

Because the correction data is a numeric value that will be added and/or subtracted to or from the video signal data by the subsequent correction processing unit 50, it has a plus or minus sign (1 bit). A configuration is possible in which a 1-bit sign is further attached to the 12-bit correction data and the resulting data is output to the correction processing unit 50, or a configuration is possible in which 11-bit correction data is generated, a 1-bit sign is attached to the 11-bit correction data to make 12-bit data, and the 12-bit data is output to the correction processing unit 50. The correction address determination table and the correction data determination table can be implemented with look-up tables.

Operation of Correction Processing Unit

An operation of the correction processing unit 50 of the present embodiment will be described next. The correction processing unit 50 refers to the 12-bit correction data output from the correction data determining unit 40, and then corrects the response velocity of the 12-bit video signal data included in the 16-bit data output from the memory control unit 30 to generate 12-bit output video signal data Dout. Specifically, the output video signal data Dout is generated by adding and/or subtracting the correction data to or from the video signal data.

In the case of using double-speed conversion, for example, the video signal at the double frame rate can be corrected with either one of the initial double-speed frame and the later double-speed frame. Alternatively, the video signal data may be corrected with both double-speed frames or the correction may not be performed.

As described above, in the configuration of the present embodiment, a value that is actually added and/or subtracted to or from a video signal is determined based on not only the data obtained through the comparison between a current frame and a previous frame, but also the data of the previous frame. Accordingly, the accuracy of over-voltage driving can be improved as compared to a configuration in which a correction amount is determined based only on the data determined from a comparison between a current frame and a previous frame.

In addition, in the present embodiment, the correction address and the correction data are determined by referring to the look-up tables. Accordingly, with the configuration of the present embodiment, it is possible to determine a correction address and correction data at high speeds.

The present embodiment has been described in the context of a liquid crystal display device that compares video signal levels for over-voltage driving in synchronization with the frame rate of an input video signal. In the configuration according to the present embodiment, video signal levels are compared to determine a correction address, and correction data is determined based on the combinations of correction addresses and video signal data. Consequently, the number of bits (resolution) of the correction data can be increased while an increase in the number of frame memories into which correction addresses are written is suppressed, so the accuracy of over-voltage driving can be improved.

### Embodiment 2

In Embodiment 1, correction data is determined by referring to a correction data determination table, whereas in Embodiment 2, an interpolation process is performed after a correction data determination table is referred to and two types of correction reference data are generated. With the configuration of the present embodiment, correction data can be determined with even higher accuracy.

The basic configuration of a liquid crystal display device according to Embodiment 2 of the present invention is the same as that of Embodiment 1 shown in FIG. 1. Accordingly, a description of the basic configuration of the liquid crystal display device is omitted here. Likewise, because the process for determining a correction address is the same as that of Embodiment 1, a description thereof is also omitted here.

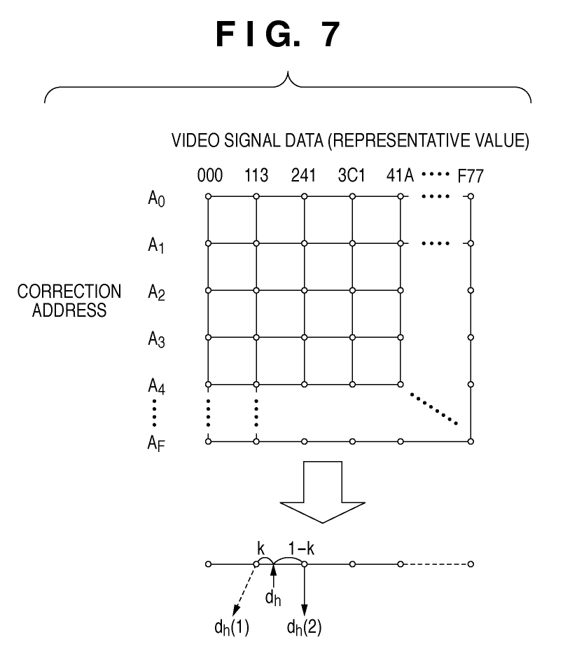

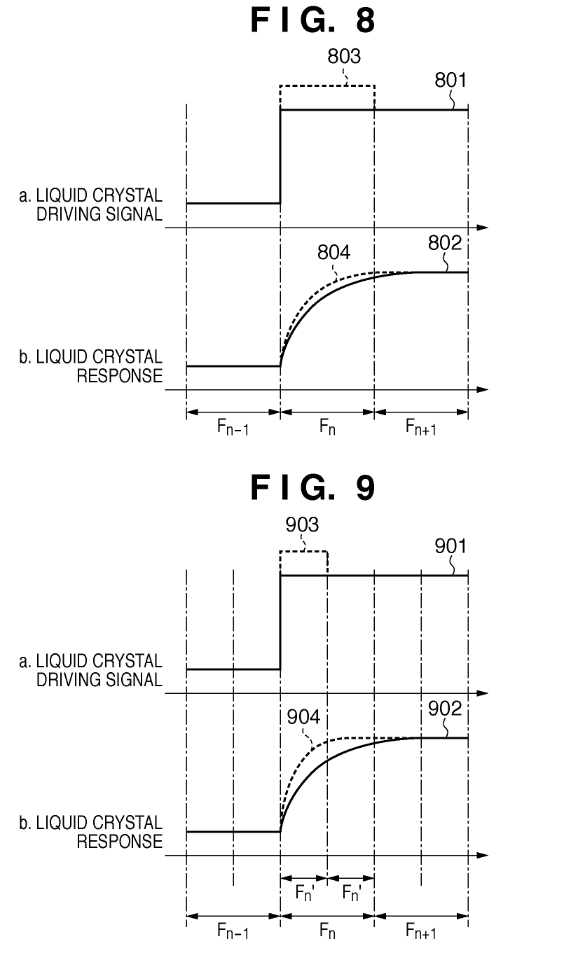

FIG. 6 is a diagram used to illustrate a correction data determination table of the present embodiment, and FIG. 7 is a diagram used to illustrate a process of interpolating correction data of the present embodiment. The correction data determination table of the present embodiment includes combinations of optimal representative values of video signal data for correction data and correction addresses as shown in FIG. 6.

The correction data determining unit 40 selects two representative values (ds1 and ds2, where ds1<ds2) that are closest to the 12-bit video signal data (indicated by “dot” here) output from the memory control unit 30, obtains two pieces of correction reference data (first correction reference data (dh1) and second correction reference data (dh2)) corresponding to these representative values, and calculates correction data (dh) according to Equations (1) and (2) (FIG. 7).

dh=k(dh2)+(1−k)dh1 (1)

k=(dot−ds1)/(ds2−ds1) (2)

In the correction address determination table of the present embodiment, a different correction address is assigned to each of n blocks into which the signal level of the previous frame's video signal data Din-1 has been divided. Accordingly, the same correction address is assigned to the same block regardless of the signal level of the input video signal data Din and, as a result, the interpolation process of the correction data determining unit 40 is facilitated.

It is also possible to improve the accuracy of the interpolation process by adopting a configuration that allows the correction data determining unit 40 to store the order in which correction addresses are arranged in the correction address determination table. In addition, the interpolation process may be performed partially depending on the configuration of the table and response characteristics.

As described above, in the present embodiment, the correction data determining unit 40 refers to the look-up table that shows the correspondence between the representative values of frame data, correction addresses, and correction data, then acquires first correction data and second correction data that correspond to two representative values closest to the frame data stored in the memory unit 10 and the correction address determined by the correction address determining unit 20, interpolates the first correction data and the second correction data, and determines the correction data. Accordingly, with the configuration of the present embodiment, a correction amount can be specified precisely without increasing the size of the frame memories, so the accuracy of over-voltage driving can be further improved.

In the present embodiment, two pieces of correction reference data are interpolated to generate correction data. By doing so, it is possible to obtain smooth interpolation data even when, for example, the number of divided blocks is small in the correction data determination table so the table is rough, and thus the accuracy of over-voltage driving can be improved.

Two embodiments have been described up to here, but in the above-described embodiments, various modifications can be made within a scope that does not depart from the gist of the invention.

### Other Embodiments

Needless to say, the present invention is also achieved by executing the program code of software that implements the functions of the above-described embodiments with a system or apparatus. In this case, the program code itself implements the functions of the above-described embodiments, and the program code falls within the technical scope of the present invention.

The program code can be, for example, supplied to a system or apparatus by being recorded to a computer-readable recording medium. A computer (or CPU or MPU) of the system or apparatus can also achieve the present invention by reading out and executing the program code stored in the recording medium. Accordingly, the recording medium that stores the program code also falls within the technical scope of the present invention.

As described above, according to each of the foregoing embodiments, it is possible to improve the accuracy of over-voltage driving while suppressing an increase in the number of frame memories in a configuration for performing comparison of video signal levels for over-voltage driving in synchronization with the frame rate of an input video signal.

According to the present invention, it is possible to provide a liquid crystal display technique with which it is possible to further improve the accuracy of over-voltage driving while suppressing an increase in the number of frame memories in a configuration for comparing video signal levels for over-voltage driving.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-155884, filed on Jun. 13, 2008, which is hereby incorporated by reference herein in its entirety.

What is claimed is:

1. A display device that receives an input of video signal data including a plurality of pieces of frame data, corrects frame data representing a frame to be displayed based on frame data of a frame adjacent to the frame to be displayed, and outputs the resulting data as data to be displayed on a liquid crystal panel, the device comprising:
a memory unit adapted to store input frame data;
a first determining unit adapted to determine a correction address used to determine a frame correction amount by comparing frame data stored in the memory unit and frame data that is currently input;
a second determining unit adapted to determine correction data that represents a correction amount of the frame data based on the frame data stored in the memory unit and the correction address; and
a correcting unit adapted to correct the frame data by adding and/or subtracting the correction amount represented by the correction data to or from the frame data stored in the memory unit.

2. The display device according to claim 1,
wherein the first determining unit reads out the frame data stored in the memory unit at the same velocity as a velocity used to input frame data, and performs a comparison, and
the second determining unit reads out the frame data stored in the memory unit at a velocity n (>1) times the velocity used to input frame data, and determines the correction data.

3. The display device according to claim 1,
wherein the first determining unit appends a determined correction address to the currently input frame data, and causes the memory unit to store the resulting data.

4. The display device according to claim 1,
wherein the first determining unit determines a correction address by referring to a look-up table that shows correspondence between data of mutually adjacent frames and correction addresses.

5. The display device according to claim 1,
wherein the second determining unit determines correction data by referring to a look-up table that shows correspondence between frame data, correction addresses, and correction data.

6. The display device according to claim 1,
wherein the second determining unit refers to a look-up table that shows correspondence between representative values of frame data, correction addresses, and correction data; acquires first correction data and second correction data that correspond to two representative values closest to the frame data stored in the memory unit and the correction address determined by the first determining unit; and interpolates the first correction data and the second correction data so as to determine the correction data.

7. A method of controlling a display device that receives an input of video signal data including a plurality of pieces of frame data, corrects frame data representing a frame to be displayed based on frame data of a frame adjacent to the frame to be displayed, and outputs the resulting data as data to be displayed on a liquid crystal panel, the method comprising the steps of:
storing input frame data;
determining a correction address used to determine a frame correction amount by comparing frame data stored in the memory unit and frame data that is currently input;
determining correction data that represents a correction amount of the frame data based on the frame data stored in the memory unit and the correction address; and
correcting the frame data by adding and/or subtracting the correction amount represented by the correction data to or from the frame data stored in the memory unit.

8. A program stored in a computer readable medium for causing a computer to function as the display device according to claim 1.

9. A computer readable recording medium in which the program according to claim 8 is stored.
